(19) United States
(12) Patent Application Publication
(10) Pub. No.: US 2024/0112103 A1
(43) Pub. Date: Apr. 4, 2024

(54) SYSTEM AND METHOD FOR RECOMMENDING NEXT BEST ACTION TO CREATE NEW EMPLOYMENT PATHWAYS FOR JOB APPLICANTS

(71) Applicants: Jake Samuel Sheinberg, Danville, CA (US); Yuvraj Multani, Danville, CA (US); Varun Malhotra, Danville, CA (US); Dylan Smith, Danville, CA (US)

(72) Inventors: Jake Samuel Sheinberg, Danville, CA (US); Yuvraj Multani, Danville, CA (US); Varun Malhotra, Danville, CA (US); Dylan Smith, Danville, CA (US)

(21) Appl. No.: 18/376,829

(22) Filed: Oct. 4, 2023

Related U.S. Application Data
(60) Provisional application No. 63/413,178, filed on Oct. 4, 2022.

(51) Int. Cl. G06Q 10/0631; G06Q 10/1053

(52) U.S. Cl. CPC G06Q 10/063112; G06Q 10/1053

(57) ABSTRACT

A system is provided to evaluate users for credentials, career objectives and other characteristics (e.g., traits). The system also evaluates job openings for credentials, career objectives, and other characteristics. A matching process is implemented to match users to job openings based on credentials, career objectives, and traits.

### RELATED APPLICATIONS

This application claims benefit of priority to Provisional U.S. Patent Application No. 63/413,178, filed Oct. 4, 2022; the aforementioned priority application being incorporated by reference in its entirety.

### TECHNICAL FIELD

Examples described herein relate to a system and method for recommending next actions to applicants.

### BACKGROUND

Currently, more than 3.5 million students graduate from US high schools and another 2 million students finish a four-year college program, and subsequently, the graduates go on to become job seekers. While there are many job sites that use search and recommendation systems to match new job seekers with open positions, a lack of prior job experience is a significant barrier for them. This work expands on the idea of what someone is capable of in a more flexible manner, by suggesting ways in which a job seeker can build their experience and credentials to match with an expanded set of available jobs. This can help new graduates with limited-to-no experience, or those looking to change careers, to be more successful in finding jobs and to match with better jobs.

Typically, existing systems match people with jobs using inputs such as a set of keywords from a candidate's resume with a job's role or title, location, duties, industry name, etc. Such a system then selects certain jobs, from a set of available jobs, as match results based on some criteria. The process of guiding a first-time job seeker who has no prior work experience is mostly left to the individual.

### BRIEF DESCRIPTION OF THE DRAWINGS

FIG. 1 illustrates a recommendation system, according to one or more embodiments.

FIG. 2 illustrates an evaluation system for use with a Recommendation System, according to one or more embodiments.

FIG. 3 illustrates a resume building assistance subsystem for use with a recommendation system, according to one or more embodiments.

FIG. 4 illustrates a method for matching users with job openings, according to one or more embodiments.

FIG. 5 is a block diagram illustrating an example consumer device for use with examples as described.

### DETAILED DESCRIPTION

Examples provide for a system and method to recommend actions which a user can take to create a new pathway to employment. In examples, a system utilizes logic (e.g., rules, machine learning processes, etc.) in performing multiple steps of a recommendation process, where increasing context and relevance is used for each user (e.g., job seeker), so that individual users are not only considered for matching with a job based on existing experience, but individual users can also receive suggestions/recommendations to build new skills so as to prepare them for getting matched with additional jobs that are better suited, higher paying or more rewarding. The suggestions and recommendations made to users can be based on data sets which are specific to the particular individual (e.g., education, initial experience, objectives, geographic location, age and other demographic information, etc.).

In additional examples, a system is provided to evaluate users for credentials, career objectives and other characteristics (e.g., traits). The system also evaluates job openings for credentials, career objectives, and other characteristics. A matching process is implemented to match users to job openings based on credentials, career objectives, and traits.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, components or sub-systems. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

Recommendation System

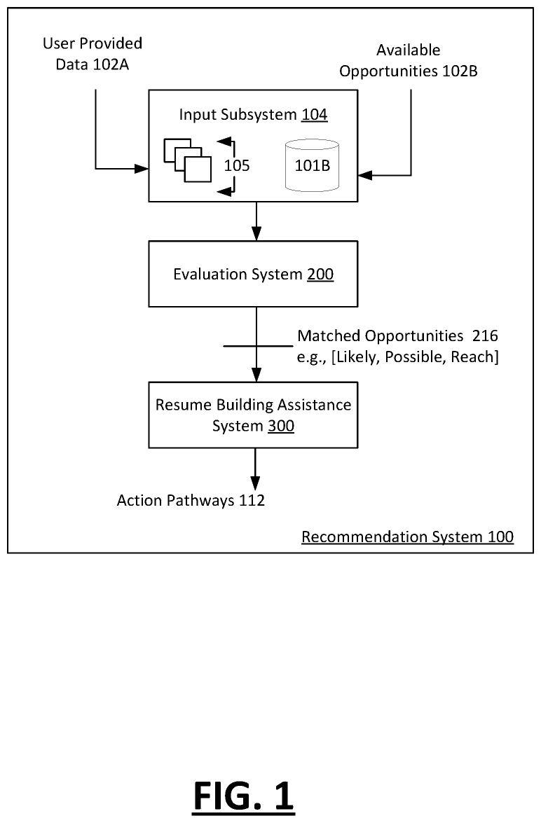

FIG. 1 illustrates a recommendation system, according to one or more examples. In examples, a recommendation system 100 implements operations to recommend jobs, opportunities, and actions (or pathways) which individual users can take to match to a job or opportunity, either presently or in the future. The recommendation system 100 includes processes that implement functionality, represented by sub-systems that include Subsystem 104 input subsystem 104, evaluation system 200, and resume building assistance system 300.

In examples, an input subsystem 104 collects user-provided data 102A. For individual users, the user-provided information 102A can include name and/or user identifier, contact information, an actual or expected graduation date for the user, prior schools or educational institutions that the user attended, degrees or credentials the user obtained, information indicating topics of study or focus (e.g., user's major or minor), the current educational institution the user is attending along with topics of study, and other information which may be of interest to a prospective employer. Additionally, the user provided information 102A can identify the user's career objective. well as a career objective. The input subsystem 104 includes one or more data stores 105 that associates one or more user records with an identifier of each user. The record(s) for each user can include, or reference corresponding user-provided information 102A.

The input subsystem 104 can also include a jobs database 101B that stores job information 102B about a plurality of jobs (alternatively characterized as opportunities).

In examples, an evaluation subsystem 200 matches users of the plurality of users with opportunities of the plurality of opportunities, using the user-provided data 102A and the job information 102B. For each match (e.g., user with job or opportunity), the evaluation subsystem 106 determines a score and/or label, representing the user's likelihood to be hired at that opportunity. In some examples, the evaluation subsystem 106 generates matched opportunities. As described with additional examples, the matched opportunities 216 are provided to resume building assistance subsystem 300, in connection with the resume building assistance subsystem 300 generating action pathways 112 for the user (as described below).

Evaluation Subsystem

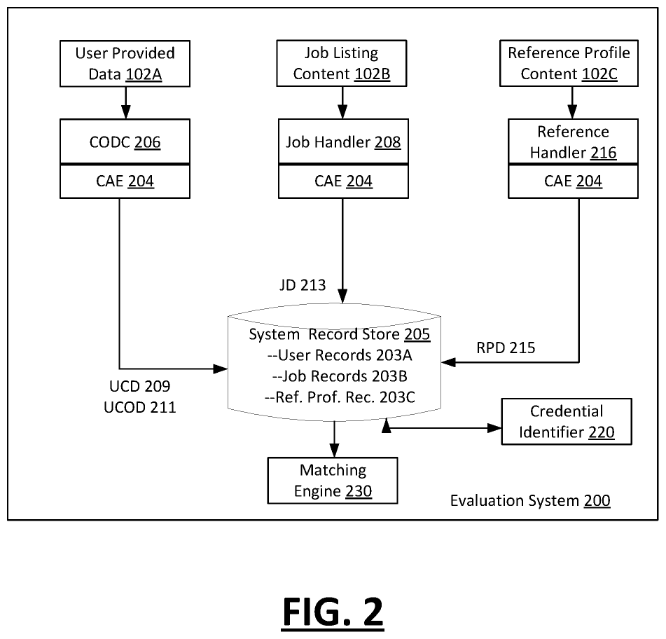

FIG. 2 illustrates an evaluation subsystem, according to one or more examples. An evaluation subsystem as described can be implemented as part of a recommendation system such as described with FIG. 1 and elsewhere.

Content Analysis

The evaluation subsystem 200 includes a content analysis component 204 that includes processes that analyze data sets (e.g., a user provided resume, a job analysis, a reference resume) for one or more types of determinations. By way of example, the types of determinations can include (i) a user career objective, (ii) criteria for job opening, and (iii) suitable characteristics and traits for job openings and careers. In examples, the content analysis engine 204 can web-based content (e.g., text content) from different sources (e.g., user provided data 102A, job openings, resumes of references, etc.), in order to generate categorical designations, labels and descriptors that are structured or otherwise tuned for a particular purpose or type of determination. Each type of determination can be associated with, for example, a schema of categorical designations or labels, where the schema can define, for example, dependencies between categorical determinations. Thus, the possible categorical designations for a particular purpose can include a tree-based or hierarchical categorical designation. Such schemas can further be predefined and tuned, trained or otherwise configured for a corresponding purpose or type of determination.

Still further, in some examples, the content analysis engine 204 can also utilize LLMs, or alternatively, utilize an LLM service, to determine, for content type (e.g., user resume, job opening, reference resume) to determine descriptors, categorical designations, labels and other information that is relevant to the particular type of determination.

In examples, the processes performed by the content analysis engine 204 can include (i) crawling or searching pre-selected data sources, (ii) parsing or tokenizing identified data sets (e.g., web content) related to the type of determination that is to be performed, (iii) performing keyword analysis, including keyword identification, keyword location and context determination, and/or (iv) performing semantic analysis, using keyword, context and natural language processing (including LLMs). Each of the processes performed by the content analysis engine 204 can be configured or tuned for a particular purpose. The content analysis engine 204 can perform the processes to generate categorical designations, labels, and descriptors for use with the particular types of determinations, as described with examples.

Career Objective Determination

In examples, a career objective determination component 206 invokes or otherwise utilizes processes of the content analysis engine 204, in connection with analysis of the user provided data 102A, to determine information about a career objective of the user. By way of example, the user-provided data 102A can include statements a user makes on an application, resume or application. The input subsystem 104 can provide one or more user interfaces to enable the user to provide such information. In examples, the user-provided data 102A can include (i) a CV or resume or other written biographical information, (ii) a cover letter, (iii) responses to background questions (e.g., such as may be generated through a user interface of the input subsystem 104), and/or (iv) responses to questions that are indicative of specific personality traits of the user (e.g., traits of leadership, team player, introvert or extrovert). The input subsystem 104 can, for example, generate one or more prompts for a user, to which the user can respond with information about their career objective, personality trait or other aspect. As an addition or variation, the content analysis engine 204 can analyze user-provided data to determine the career objectives and/or personality traits of the user.

In examples, for a given user, the content analysis engine 204 performs career objective analysis for user-provided data 102A. The processes performed can determine a career objective data set 211 for the user. The career objective data set 211 can include, for example, one or more categorical designations, including sub categorical designations, which collectively define characteristics such as job title, responsibility level, earning potential, and/or type of responsibilities. In some examples, the schema or structure for the career objective data set is predefined in whole or in part. For example, a library of job postings and online resumes can be analyzed to determine the schema for categorical designations of the career objective. Accordingly, in examples, the career objective data set 211 can be defined at least in part by a hierarchical categorical structures, defining the field, subfield, title, responsibility level, earning, geographic location, employer type (e.g., large company versus start up, nonprofit, etc.), requisite credentials, and other characteristics. Additionally, the career objective data set 211 can be associated with predefined labels, such as labels for earning range and responsibility level. In some examples, the objectives analysis 204 can also utilize LLMs, or alternatively, utilize an LLM service, to determine information relating to user's career objective. For example, an LLM can be utilized to analyze user provided data 102A (e.g., resume, cover letter, reference letters) to determine or infer categorical designations and labels that are in line with an objective of the user.

The career objective determination component 206 can implement or otherwise utilize processes of the content analysis engine 204, as applied to user-provided data 102A, to determine the career objective data set 211 for individual users. The career objective data set 211 can be associated with a user record 203A of a system records store 205. The user record 203A can associate an identifier of the user with references or links to user-provided information, as well as career objective data set 211 as determined for the particular user. In examples, the career objective data set is formatted to be programmatically accessible by other components or processes, such as by the Resume Building Assistance System 110, as further described with examples.

User Credential Analysis

Processes represented by user credential analysis 202 can invoke or otherwise utilize content analysis engine 204 to analyze the user-provided data 102A. The analysis can generate user credential information, identifying, for example, education level and quality, experience level, skills, professional credentials and licenses, and other types of information that may qualify are enhance the user's ability to obtain a job (“user credentials data set 203”). The determined credentials of the user can be in the form of categorical designations, including hierarchical determinations, labels and descriptors. The user credential data set 211 can also be stored as part of or in association with individual records 203A of users.

Job Characteristic Analysis

In examples, processes represented by job handler 208 identify sources for job openings and listings. The sources can include, for example, URLs and APIs job boards, social networks, web sites for companies and enterprises, universities, etc. In this way, the job handler 208 maintains a list of active sources for job openings. Further, the job handler 208 can update the list to add or remove sources. The job handler 208 can check job opening sources for new job opening. Further, the job handler 208 can determine a frequency to check known sources for new job openings.

The job handler 208 can invoke or otherwise utilize processes of the content analysis engine 204 to analyze content provided with job openings. Each job opening can be associated with one or more categorical designations, including sub-categorical designations that are structured in accordance with a predefined schema (e.g. hierarchical arrangement). Additionally, labels can be determined and associated for individual job openings. Collectively, each job opening can be associated with, for example, an employer, a title, a geographical location, a responsibility level, a salary, credentials including education level and experience level, and various other types of information (collectively “job data set 213”). Further, the job data set 213 can include a career designation, which can be used to match with users having same or similar career objectives. For each job opening, the job handler 208 can generate and maintains a job record 203B that associates an identifier of the job opening with the job data set 213, as well as a status of the job opening (e.g., new, open, archived, etc.). The job records 203B may be stored with the one or more system data stores 205.

Further, the job handler 208 can use processes of the content analysis engine 204 to rank or prioritize credentials for job openings. For example, the content analysis engine 204 can score, weight or rank credential data items of the job data set 213 that correspond to a determined or requisite credential. As illustrated with some examples, a credential can correspond to, for example, an education level, a type of degree, an experience level or a skill (e.g., knowledge of a particular programming language), or other characteristic that can be obtained for a particular job.

In examples, the analysis performed on job opening content can identify key words or terminology that is indicative of desired personality traits, such as, for example, leadership, or team member. The job opening content can also indicate words that are indicative of whether the user should be extroverted or introverted. For example, terminology such as high energy, self-starter, communicated etc. can be strong indicators that the desired personality trait for the job opening is an extrovert. Conversely, some positions are inherently introverted, unless the descriptions indicate otherwise. For example position of scientific researcher can reflect an individual personality traits of being introverted.

Reference Profile Analysis

In examples, the reference handler 218 also implements web-based processes to identify reference profiles. Reference profiles can include online resumes, CVs, and biographies of individuals that are known to currently hold a particular job. The reference handler 218 can include, for example, processes that use URLs and APIs to crawl/search online web sources, using one or more program or web interfaces, to identify reference profiles.

The reference handler 218 can invoke, or otherwise use processes of the content analysis engine 204 to analyze reference profiles. Based on the analysis, each reference profile can be associated with a reference profile record, where the reference profile record is associated with a set of categorical designations, including hierarchical designations, as well as labels and descriptors. The reference handler 218 can associate each reference profile with, for example, an employer, a title, a geographical location, a responsibility level, a salary, and a subset of credentials for the person, including education level, type (e.g., type of college degree) and experience level (collectively “reference profile data set 215”). In examples, the reference handler 218 generates a reference record 203C for each reference profile, where the reference record links an identifier with the reference profile data set 215 of the particular reference.

Additionally, in examples, the content analysis engine 204 can also implement processes, represented by credential identifier 220, to use information determined from 102A, job listing content 102B, and reference profile content 102C, to identify a dictionary of credentials, where the dictionary of labels describe prerequisite skills, experiences, and training necessary for current job openings. The credential identifier 220 can use machine learning (e.g., Natural Language Processing) to create a dictionary of labels that describe prerequisite skills, experiences, and training necessary for available jobs. The credential identifier 220 can also interprets keywords, formatting, order, and repetition to determine individual credentials magnitude.

When analyzing the user provided data 102A for a given user, the content analysis engine 204 can also implement processes to normalize credential information of user provided data, job openings, and reference resumes. The credential normalization can normalize credentials, which may be formatted or defined by into a normalized structure for subsequent analysis and comparison. The credentials can be stored as labels, or categories, with, for example, the user record.

Job Matching

For a given user, a job matching engine 230 invokes processes of the content analysis engine 204 to match users with job openings. As described, the matching engine 230 can respond to input inquiries from users by (i) retrieving one or more records 203A of the user from the system record store 205, and (ii) perform matching operations between the retrieved user information (e.g., user credential data set 209, career objective data set 211) and information regarding job openings (e.g., job credential information 213 as provided in job records 203B). In some examples, the job matching engine 230 selects a candidate set of job openings based on status (e.g., recency, job remains open), and stated objectives of the job opening which match the career objective data set 211 of the user. The matching engine 230 then performs matching operations to match the user with job openings, based on, for example, the user credential data set 209 and the job credential data set 213. The matching operations can entail determining a similarity between the user credential data set and the job credential data set of each job opening in the candidate set. Based on similarity matching, the matching engine 230 can return a matching set of job openings to the user (e.g., via a user interface provided with the input subsystem 104). The matching engine 230 can return a set of matching job openings to the user, via a user interface (e.g., web page, application screen, etc.).

In examples, the matching set of job openings can be ranked, sorted or grouped in any one of multiple ways—for example, job openings may be ranked in accordance with how closely the job opening matches the user's credentials (e.g., high similarity score). As an addition or variation, job openings that meet the career objective of the user can be scored to reflect the degree of matching. The degree of matching can reflect a probabilistic determination of whether the user can/will be hired for the job opening. In some examples, scoring can include numerical values that represent the user's likelihood of being hired for a specific job. In examples, the generated value is a floating point number within the range of zero and one.

In examples, each job opening of the candidate set can be associated with a score or categorical designation that is based on a score. By way of example, each job opening of the candidate set can be associated with a score or category, reflecting, for example: i) “likely” category or score—where the user is fully qualified, such as in the case where the user exceeds or excels at all of the requisite credentials listed for the job opening, (ii) “possible”—reflecting a scenario where the user's credentials are likely sufficient for the job position, but where the user may not be the most qualified applicant, and (iii) “reach”—reflecting a supplier with the user's credentials are likely insufficient, but where the user may have sufficient credentials to obtain the job position.

In determining the user credential data set, the job matching engine 230 can implement processes that normalize the user's credentials by format and/or categorical designation. The user credential data set can be stored or linked with the user record, such that the user credential data set and career objective data set are also linked.

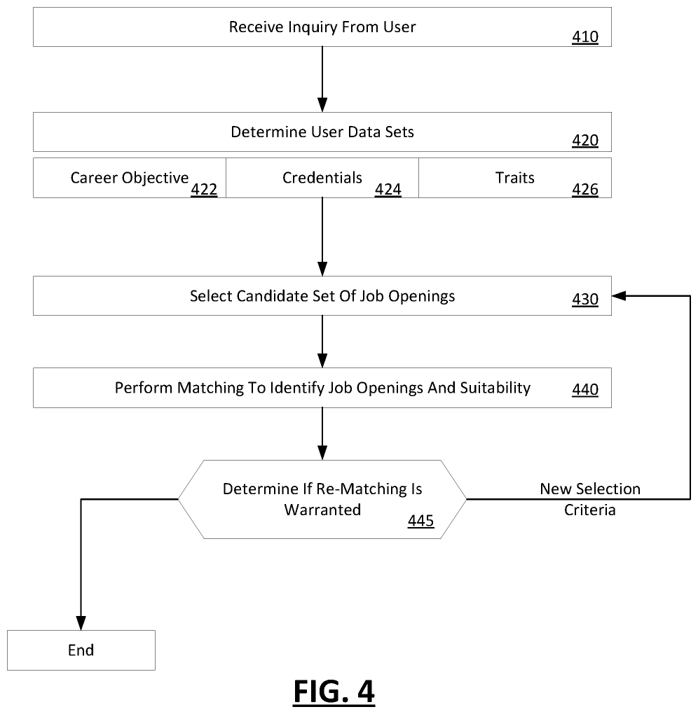

The matching engine 230 can return a matching set of job openings to the user. An example of a method for implementing the matching engine is provided with FIG. 4.

Resume Building Assistance (Sub-)System

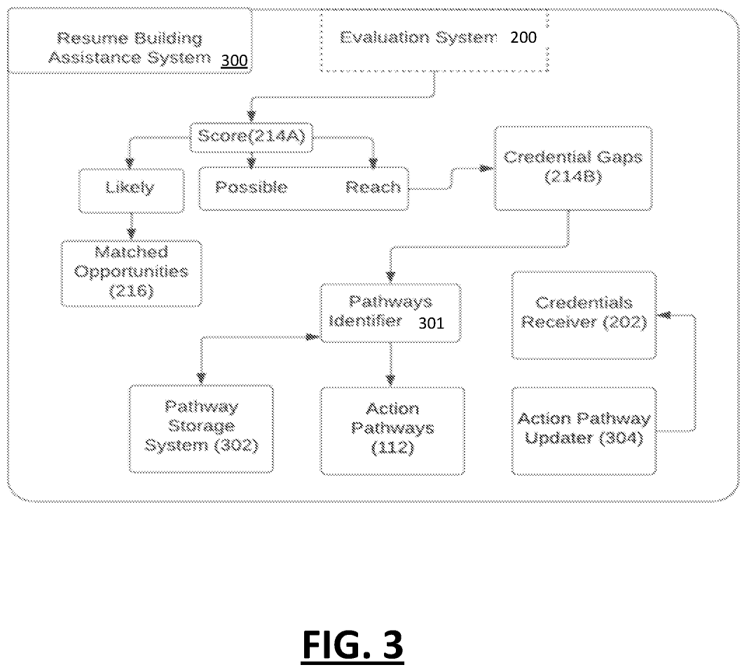

FIG. 3 illustrates the resume building assistance subsystem 300, according to one or more examples. In examples, resume building assistance subsystem 300 is implemented to generate one or more action pathways corresponding to a set of opportunities for whom the label is computed as, for example, “Possible” or “Reach”. The sub-system 300 can be implemented as part of the recommendation system 100.

With further reference to FIG. 3, processes represented by pathways identifier 301 can compute an action pathway 112 for select opportunities. The select opportunities can correspond to existing jobs, or alternatively, career classifications that correlate to existing job opportunities (rather than specific job opportunities). The pathway identifier 301 can further identify candidate opportunities for individual users. The candidate opportunities can correspond opportunities that are labeled as, for example, “Possible” or “Reach”. Further, in examples, the candidate opportunities can be identified using missing credentials identified by credentials gaps 214B and the actions pathway 112.

The Resume Building Assistance System 110 can implement the evaluation subsystem 200, as well as components such as a necessary credentials identifier 210, to determine a likely opportunity. In some examples, recursive processes (including processes to store each step in the pathway storage system 302) are performed until the evaluation system 108 reaches a candidate opportunity (e.g., opportunity yielding a “Likely” classification).

In examples, an action pathway 112 is a sequential plan, indicating the experiences required in order to achieve the user's job objectives and those that can help raise their score 214A “Likely” and hence lead to matched opportunities. In some examples, the sequential plan can be determined through analysis of reference profiles. A reference profile resume can be obtained and analyzed (e.g., using the reference analysis component 218 and content analysis engine 204). The resume can be parsed for credentials (e.g., education, career, experience) and paired with characteristics of the job opening. Over many profiles, the characteristics of a category of jobs held by multiple reference profile can be paired with characteristics of their credentials and personality. Through, for example, statistical analysis and aggregation, action pathway 112 for a category of jobs can be determined, through the credentials and other characteristics of the reference profiles. In turn, when a user identifies a career objective or “dream job”, the aggregated profiles can be used to determine educational and experience credentials common amongst those reference profiles who held the same or similar job.

In examples, these experiences comprising the action pathway 112 are built from previously determined sequences in the pathway storage system 302 and presented to the user to implement. The action pathway updated 304 repeatedly monitors and parses a user profile for credential updates and then initiates the evaluation system 200.

In examples, once a user takes action on the action pathway 112, the user provides an update of their action to the resume building assistance system 110 through action pathway updated 304. This update can trigger a repeat of the previous processes by invoking credential receiver 202 until an opportunity is found where the user's employability score 214A reads as “Likely”, which in turn, leads to the system finding one or more matched opportunities 216.

Methodology

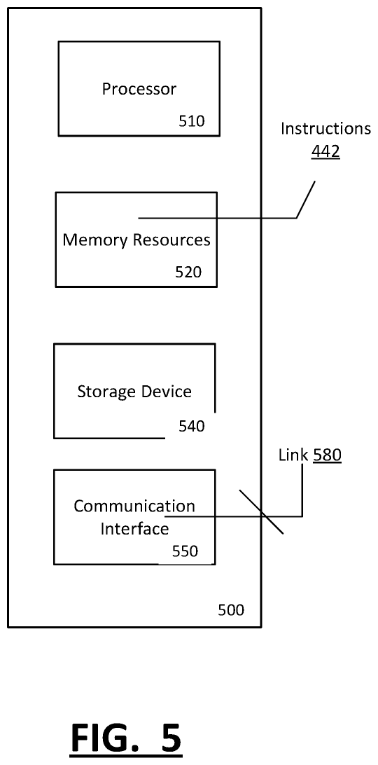

FIG. 4 illustrates a method for matching users with job openings, according to one or more embodiments. A method such as described with an example of FIG. 4 can be implemented using a computer system, such as one described with examples of FIG. 5. Reference may be made to elements of system such as shown by FIGS. 1-3 for purpose of illustrating suitable functionality for performing a step or sub-step being described.

In an example, input sub-system 104 receives an inquiry from the user (step 410). Initially, the user may perform onboarding, such as completing an application, providing a resume, cover letter and/or answering questions or prompts generate through the user interface of the input subsystem 104. In some examples, questions can be asked of the user to solicit responses that are indicative of personality or character traits. By way of example, the traits can include a leadership trait (e.g., does the user exhibit leadership), a team member trait (e.g., user does the user exhibit a trait of being able to work with others, cohesively in a group to further, the objective), and/or an introvert trait (e.g., those a user exhibit a tendency to be shy, noncommunicative, or work outside a team environment). As an addition or variation, the traits can be inferred from the user work experience (e.g., the type of job the person previously held). Still further, the system 100 can identify a current or previous job the user has or previously had, search the system record store 205 for a record of the job opening, and determine whether the record for the job opening includes any characteristics that correlate up otherwise correspond to one or more of traits.

In some examples, the system contemplates maintaining relationships with users over an extended period of time (e.g., years). Thus, the user may update their resume, career objectives, user credentials and other information over time. The user may submit inquiries to the system 100 for purpose of matching to existing job openings, determining a career path, and/or determining their suitability for particular job opening a career path.

Responsive to the user inquiry, the system 100 determines one or multiple sets of user data (step 420). For example, processes the content analysis engine 204 can be used to determine data sets representing the user's credentials (step 422), career objective (step 424), and traits (step 426). The determinations can be reflected by categorical designations, labels, scores, or descriptors.

In step 430, the system 100 can implement a matching process that includes determining a candidate set of job openings for a user, based on the multiple sets of user data (as determined in step 420). In some examples, the candidate set of job openings to be identified by matching the career objective of the user with a career objective category or designation of the job opening. Further, the candidate set of job openings can be identified based on status (e.g., whether the job opening is recent or old, active or closed, etc.) and geographic region (e.g., weather the position would locate the user in a preferred are nonpreferred geographic region).

In step 440, the system 100 performs matching operations to match the user with a set of job openings that are suitable for the user. The determination suitability can be based on user credentials, such as the user's education level and/or experience, as compared with requisite or desired credentials of the job opening. The matching engine 230 can utilize information maintained with the user record 211 and job records 213 of the candidate set of job openings when performing the matching operations. For each job opening the candidate set, the suitability or degree of matching between the user and the job opening can be determined or expressed in terms of a score, such as a numerical value score. As an addition or variation, the suitability or degree of matching can be expressed in terms of the categorical designation reflecting a likelihood that the user can or will be hired for the job opening (e.g., “likely”, “possible”, “reach”).

In step 445, the system 100 makes a determination as to whether rematching is warranted, based in part on results of step 440. A determination of rematching may be warranted can be based on (i) the candidate set of job openings not identifying matches (or sufficient matches) where the user is likely or highly matched, (ii) the candidate set of job openings not meeting preferences of the user such as salary, and/or (iii) the determination that the traits of a job opening are poor matches to traits that are characteristic of the user. In the latter case, mismatch between traits can inferred job where the user may have a little success (if obtained), happiness or less chance to obtain. In such case, step 430 can be repeated, with additional or alternative filtering criteria for identifying candidate job openings. For example candidate job openings can be determined based on trait associated with the job opening. In variations, determination step 440 in step 445 can be made at one time. Alternatively, a method such as described can be performed iteratively are progressively.

Computer System

FIG. 5 illustrates a computer system on which one or more embodiments can be implemented. A computer system 500 can be implemented on, for example, a server or combination of servers. For example, the computer system 400 may be implemented as part of a system as described with examples of FIG. 1, or sub-systems as described with FIG. 2 and FIG. 3.

In one implementation, the computer system 500 includes processing resources 510, memory resources 520 (e.g., read-only memory (ROM) or random-access memory (RAM)), a storage device 540, and a communication interface 450. The computer system 500 includes at least one processor 510 for processing information stored in the main memory 520, such as provided by a random-access memory (RAM) or other dynamic storage device, for storing information and instructions which are executable by the processor 510. The main memory 520 also may be used for storing temporary variables or other intermediate information during execution of instructions to be executed by the processor 510. The computer system 500 may also include the memory resources 520 or other static storage device for storing static information and instructions for the processor 510. The storage device 540, such as a magnetic disk or optical disk, is provided for storing information and instructions.

The communication interface 550 enables the computer system 500 to communicate with one or more networks (e.g., cellular network) through use of the network link 580 (wireless or a wire). Using the network link 580, the computer system 500 can communicate with one or more computing devices, specialized devices and modules, and one or more servers. The executable instructions stored in the memory 530 can include instructions 542, to implement a recommendation system 100 such as described with an example of FIG. 1.

As such, examples described herein are related to the use of the computer system 500 for implementing the techniques described herein. According to an aspect, techniques are performed by the computer system 500 in response to the processor 510 executing one or more sequences of one or more instructions contained in the memory 520. Such instructions may be read into the memory 520 from another machine-readable medium, such as the storage device 540. Execution of the sequences of instructions contained in the memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

### CONCLUSION

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A computing system comprising:
one or more processors;
a memory to store a set of instructions;
wherein the one or more processors perform operations that include:
obtaining information about a plurality of users and a plurality of opportunities;
based on the information, matching individual users with corresponding opportunities, including determining a likelihood that the user will be hired for the opportunity.

2. The computing system of claim 1, wherein the operations further comprise: for a given user, determining, based on the matchings and the information, an action pathway to facilitate the given user in meeting an objective at a future time interval.
